(19) United States
(12) Patent Application Publication
(10) Pub. No.: US 2024/0281361 A1
(43) Pub. Date: Aug. 22, 2024

(54) BINTYPER: TYPE CONFUSION BUG DETECTION FOR C++ PROGRAM BINARIES

(71) Applicant: Korea University Research and Business Foundation, Seoul (KR)

(72) Inventors: Seungjoo KIM, Seoul (KR); Dongju KIM, Seoul (KR)

(73) Assignee: Korea University Research and Business Foundation, Seoul (KR)

(21) Appl. No.: 18/019,581

(22) PCT Filed: Jul. 15, 2021
(86) PCT No.: PCT/KR2021/009092

§ 371 Date: Jul. 13, 2023

(30) Foreign Application Priority Data
Aug. 6, 2020 (KR) 10-2020-0098768
Nov. 11, 2020 (KR) 10-2020-0150127

(51) Int. Cl. G06F 11/36

(52) U.S. Cl. CPC G06F 11/362

(57) ABSTRACT

According to some exemplary embodiments of the present disclosure, disclosed is a method for detecting a type confusion bug of a binary code target of an object-oriented programming language using a processor of a computing device. The method may include: restoring at least one class and an inheritance relationship of at least one class by analyzing a binary code of an object-oriented programming language; recognizing a layout of at least one class by using at least one class and the inheritance relationship; and detecting the type confusion bug by using the layout of at least one class.

### TECHNICAL FIELD

The present disclosure relates to software security bug detection, and particularly, to binary security bug generation detection through a dynamic analysis.

### BACKGROUND ART

Object-oriented programming is a paradigm that wants to express a program through a set of numerous objects and intersections of the objects. The object-oriented programming is easily maintained and has high reusability, so the object oriented programming is used for complex and large software development. C++ is used for developing a lot of software in which performance is important such as Chrome and Firefox among object-oriented programming languages such as C++, JAVA, Python, etc. One of the important functions to support the polymorphism of object-oriented language is typecasting between objects. The typecasting allows the same object to be converted into a target type from an original type. Through this, a developer can create a code concisely and intuitively by typecasting (upcasting) and handling various derived class to a common parent class. In this case, when a type-specific task is required with respect to a specific derived class, typecasting (downcasting) from the parent class to the derived class may be performed.

Meanwhile, since the derived class includes the parent class, upcasting operates safely. However, when the parent class is downcasted to the derived class, it cannot be known whether a target object is can be actually typecasted to the derived class (compatibility). When the object is typcasted to a class type which is not compatible, the program handles the object as a wrong type (this is called Type confusion bug or Bad casting). As a result, an operation not intended by the developed occurs, and an attacker abuses this to develop exploit.

C++ as a typecasting operator that verifies the compatibility in runtime provides dynamic_cast. However, the dynamic_cast is slower than static_cast which is a typecasting operator that verifies the compatibility only in compile time. Therefore, software in which the performance is important, such as OS, Web browser, etc., performs typecasting through the static_cast. However, since the static_cast does not verify the compatibility of type conversion in the runtime, a type confusion bug can be generated. The following examples show Type confusion bug examples discovered in widely used software such as a web browser: ChakraCore(CVE-2020-1219), Adobe Reader(CVE-2019-8221), Vbscript(CVE-2017-8618)

Previous studies for detecting the runtime type confusion bug are performed at source code level. The studies inserts a code for verifying typecasting compatibility into a point used by the typecasting operator in the process of compiling a C++ source code to detect the type confusion bug generated in the runtime. UBSan (Non-patent document [18]) of Google verifies the typecasting compatibility based on RTTI by replacing the static_cast with the dynamic_cast. CaVer (Non-patent document [31]), TypeSan (Non-patent document [26]), and HexType (Non-patent document [28]) verify the typecasting compatibility based on a custom type metadata structure. However, previous studies can only be used for white box testing. Since black-box testing is performed with only a binary given without the source code, it is difficult to apply the studies (Non-patent documents [31], [26], and [28]) to the Black-box testing.

The previous studies (Non-patent document GFlags [10], Application Verifier [1], Electric Fence [9], RetroWrite [21], Valgrind [19], and DrMemory [7]) which may be utilized in the black-box testing are used for detecting memory corruption bugs of Object lifetime issue (Use-after-free) and Boundary issue (Buffer overflow, Out-of-bound access) types. Since the studies is not designed for detecting the type confusion bug, the studies have a limitation that only Type confusion bug (Access beyond type-confused object boundary) of a specific situation can be detected.

Therefore, there may be the need for the study for a runtime type confusion tool which can be applied to the C++ binary.

### Prior Art Document

[1] Application Verifier. https://docs.microsoft.com/enus/windows-hardware/drivers/devtest/applicationverifier.

[2] Automation Techniques in C++ Reverse Engineering. https://cfp.recon.cx/reconmt12019/talk/FGCZYU/.

[3] Chromium Issue 983137. https://bugs.chromium.org/p/chromium/issues/detail?id=983137.

[4] CVE-2017-8618. https://cve.mitre.org/cgi-bin/cvename.cgi?name=CVE-2017-8618.

[5] CVE-2019-8221. https://cve.mitre.org/cgi-bin/cvename.cgi?name=CVE-2019-8221.

[6] CVE-2020-1219. https://cve.mitre.org/cgi-bin/cvename.cgi?name=CVE-2020-1219.

[7] Dr. Memory. https://drmemory.org/.

[8] Dyninst. https://www.dyninst.org.

[9] Electric Fence. https://docs.microsoft.com/en-us/windows-hardware/drivers/devtest/applicationverifier.

[10] GFlags. https://docs.microsoft.com/en-us/windowshardware/drivers/debugger/gflags.

[11] Google Chrome. https://www.google.com/chrome.

[12] Google PDFium. https://opensource.google/projects/pdfium.

[13] Hex-Rays IDA Disassembler. https://www.hex-rays.com/products/ida/.

[14] Itanium C++ ABI. https://refspecs.linuxbase.org/cxxabi-1.86.html.

[15] Miasm: Python reverse engineering framework. https://github.com/cea-sec/miasm.

[16] Mozilla Firefox. https://www.mozilla.org/en-US/firefox/products.

[17] Pin—A Dynamic Binary Instrumentation Tool. https://software.intel.com/content/www/us/en/develop/articles/pin-a-dynamic-binary-instrumentationtool.html.

[18] UndefinedBehaviorSanitizer (UBSan). https://www.chromium.org/developers/testing/undefinedbehaviorsanitizer.

[19] Valgrind. https://valgrind.org/.

[20] DEWEY, D., AND GIFFIN, J. T. Static detection of c++ vtableescape vulnerabilities in binary code. In NDSS (2012).

[21] DINESH, S. Retrowrite: Statically instrumenting cots binariesfor fuzzing and sanitization. PHD thesis, Purdue University Graduate School, 2019.10

[22] ELSABAGH, M., FLECK, D., AND STAVROU, A. Strict virtual call integrity checking for c++ binaries. In Proceedings of the 2017 ACM on Asia Conference on Computer and Communications Security (2017), pp. 140-154.

[23] ERINFOLAMI, R. A., AND PRAKASH, A. Declassifier: Classinheritance inference engine for optimized c++ binaries. In Proceedings of the 2019 ACM Asia Conference on Computer and Communications Security (New York, NY, USA, 2019), Asia CCS'19, Association for Computing Machinery, p. 28-40.

[24] FOKIN, A., TROSHINA, K., AND CHERNOV, A. Reconstruction of class hierarchies for decompilation of c++ programs. In 2010 14th European Conference on Software Maintenance and Reengineering (2010), pp. 240-243.

[25] GAWLIK, R., AND HOLZ, T. Towards automated integrity protection of c++ virtual function tables in binary programs. In Proceedings of the 30th Annual Computer Security Applications Conference (2014), pp. 396-405.

[26] HALLER, I., JEON, Y., PENG, H., PAYER, M., GIUFFRIDA, C., BOS, H., AND VAN DER KOUWE, E. TypeSan: Practical type confusion detection. In Proceedings of the ACM Conference on Computer and Communications Security (oct 2016), vol. 24-28-October-2016, Association for Computing Machinery, pp. 517-528.

[27] JANG, D., TATLOCK, Z., AND LERNER, S. Safedispatch: Securing c++ virtual calls from memory corruption attacks. In NDSS (2014).

[28] JEON, Y., BISWAS, P., CARR, S., LEE, B., AND PAYER, M. Hex Type: Efficient detection of type confusion errors for C++. In Proceedings of the ACM Conference on Computer and Communications Security (October 2017), Association for Computing Machinery, pp. 2373-2387.

[29] JEON, Y., HAN, W., BUROW, N., AND PAYER, M. Fuzzan: Efficient sanitizer metadata design for fuzzing.

[30] JIN, W., COHEN, C., GENNARI, J., HINES, C., CHAKI, S., GURFINKEL, A., HAVRILLA, J., AND NARASIMHAN, P. Recovering C++ objects from binaries using inter-procedural dataflow analysis. In Proceedings of ACM SIGPLAN on Program Protection and Reverse Engineering Workshop 2014 (New York, NY, USA, 2014), PPREW'14, Association for Computing Machinery.

[31] LEE, B., SONG, C., KIM, T., AND LEE, W. Type casting verification: Stopping an emerging attack vector. In Proceedings of the 24th USENIX Conference on Security Symposium (Berkeley, CA, USA, 2015), SEC'15, USENIX Association, pp. 81-96.

[32] LEE, J., AVGERINOS, T., AND BRUMLEY, D. Tie: Principled reverse engineering of types in binary programs.

[33] LIN, Z., ZHANG, X., AND XU, D. Automatic reverse engineering of data structures from binary execution. In Proceedings of the 11th Annual Information Security Symposium (2010), pp. 1-1.

M[34] ERCIER, D., CHAWDHARY, A., AND JONES, R. dynstruct: An automatic reverse engineering tool for structure recovery and memory use analysis. In 2017 IEEE 24th International Conference on Software Analysis, Evolution and Reengineering (SANER) (2017), IEEE, pp. 497-501.

[35] PAWLOWSKI, A., CONTAG, M., VAN DER VEEN, V., OUWEHAND, C., HOLZ, T., BOS, H., ATHANASOPOULOS, E., AND GIUFFRIDA, C. Marx: Uncovering class hierarchies in c++ programs. In NDSS (2017).

[36] PRAKASH, A., HU, X., AND YIN, H. vfguard: Strict protection for virtual function calls in cots c++ binaries. In NDSS (2015).

[37] SARBINOWSKI, P., KEMERLIS, V. P., GIUFFRIDA, C., AND ATHANASOPOULOS, E. Vtpin: practical vtable hijacking protection for binaries. In Proceedings of the 32nd Annual Conference on Computer Security Applications (2016), pp. 448-459.

[38] SCHWARTZ, E. J., COHEN, C. F., DUGGAN, M., GENNARI, J., HAVRILLA, J. S., AND HINES, C. Using logic programming to recover c++ classes and methods from compiled executables. In Proceedings of the 2018 ACM SIGSAC Conference on Computer and Communications Security (2018), pp. 426-441.

[39] SEREBRYANY, K., BRUENING, D., POTAPENKO, A., AND VYUKOV, D. Addresssanitizer: A fast address sanity checker. In Presented as part of the 2012 {USENIX} Annual Technical Conference ({USENIX} {ATC} 12) (2012), pp. 309-318.

[40] SLOWINSKA, A., STANCESCU, T., AND BOS, H. Howard: A dynamic excavator for reverse engineering data structures. In NDSS (2011).

[41] VAN DER VEEN, V., GKTAS, E., CONTAG, M., PAWOLOSKI, A., CHEN, X., RAWAT, S., BOS, H., HOLZ, T., ATHANASOPOULOS, E., AND GIUFFRIDA, C. A tough call: Mitigating advanced code-reuse attacks at the binary level. In 2016 IEEE Symposium on Security and Privacy (SP) (2016), IEEE, pp. 934-953.

[42] YOO, K., AND BARUA, R. Recovery of object oriented features from c++ binaries. In 2014 21st Asia-Pacific Software Engineering Conference (2014), vol. 1, pp. 231-238.

[43] ZHANG, C., SONG, C., CHEN, K. Z., CHEN, Z., AND SONG, D. Vtint: Defending virtual function tables' integrity. In Symposium on Network and Distributed System Security (NDSS) (2015), vol. 160, pp. 173-176.

[44] ZHANG, C., SONG, D., CARR, S. A., PAYER, M., LI, T., DING, Y., AND SONG, C. Vtrust: Regaining trust on virtual calls. In NDSS (2016)

### DISCLOSURE

### Technical Problem

The present disclosure has been made in an effort to provide a binary security bug generation detection technique through a dynamic analysis.

However, technical objects of the present disclosure are not restricted to the technical object mentioned above. Other unmentioned technical objects will be apparently appreciated by those skilled in the art by referencing to the following description.

### Technical Solution

In order to solve the problem, according to some exemplary embodiments of the present disclosure, disclosed is a method for detecting a type confusion bug of a binary code target of an object-oriented programming language using a processor of a computing device. The method may include: restoring at least one class and an inheritance relationship of the at least one class by analyzing a binary code of the object-oriented programming language: recognizing a layout of the at least one class by using the at least one class and the inheritance relationship; and detecting the type confusion bug by using the layout of the at least one class.

Further, the restoring of the at least one class and the inheritance relationship of the at least one class by analyzing the binary code of the object-oriented programming language may include extracting at least one virtual function table for each of at least one polymorphic class, recognizing a constructor and a destructor for each of the at least one polymorphic class by using the at least one virtual function table, and restoring the inheritance relationship of the at least one class through an overwrite analysis using the constructor and the destructor.

Further, the constructor may be a method used when the object is generated in the at least one class, and the destructor may be a method used when the object is destructed in the at least one class.

Further, the recognizing of the layout of the at least one class by using the at least one class and the inheritance relationship may include recognizing a size of each of the at least one class, and recognizing the layout of at least one class by using the size of each of the at least one class and the inheritance relationship.

Further, the recognizing of the size of each of the at least one class may include recognizing a start offset for the at least one class from a register of a CPU, recognizing the size of the object of the at least one class to recognize an end offset for the at least one class, and recognizing the size of each of the at least one class by using the start offset and the end offset.

Further, the detecting of the type confusion bug by using the layout of the at least one class may include executing at least one normal binary code to identify at least one target area for the object related to the at least one class, and detecting the type confusion bug of the binary code based on the target area.

Further, the executing of the at least one normal binary code to identify the at least one target area for the object related to the at least one class may include determining whether an assembly instruction accesses an object stored in a memory when the assembly instruction of the at least one normal binary code accesses the memory, recognizing an address of an access target when it is determined that the assembly instruction accesses the object stored in the memory, recognizing an offset of the object by calculating a difference value between the address of the access target and a start point of the object, and identifying the target area for the offset of the object by using the offset of the object and the layout of the at least one class.

Further, the detecting of the type confusion bug of the binary code based on the target area may include writing a memory address and a class type of a target object when a target binary is executed and a class constructor is called, and when access to the target object occurs, determining whether the type confusion bug occurs according to whether the target area related to the target object is present.

Further, when the access to the target object occurs, the determining of whether the type confusion bug is generated according to whether the target area related to the target object is present may include when the target area related to the target object is not present in the written class type, determining that the type confusion bug is generated.

Technical solving means which can be obtained in the present disclosure are not limited to the aforementioned solving means and other unmentioned solving means will be clearly understood by those skilled in the art from the following description.

### Advantageous Effects

According to an exemplary embodiment of the present disclosure, a technique of detecting a type confusion bug generated during execution of a C++ program in which only a binary is given without a source code can be provided to a user. Therefore, the user can detect the type confusion bug while not possessing the source code.

Effects which can be obtained in the present disclosure are not limited to the aforementioned effects and other unmentioned effects will be clearly understood by those skilled in the art from the following description.

### DESCRIPTION OF DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the specific detailed matters. In other examples, known structures and apparatuses are illustrated in a block diagram form in order to facilitate description of the one or more aspects.

FIG. 1 is a block diagram of a server for detecting a type confusion bug of a C++ program binary target according to some exemplary embodiments of the present disclosure.

FIG. 2 is a flowchart for describing an example of a method for detecting a type confusion bug according to some exemplary embodiments of the present disclosure.

FIG. 3 is a diagram for describing an assembly expression of a C++ source code according to some exemplary embodiments of the present disclosure.

FIGS. 4, 5, 6, and 7 are diagrams for describing a method for detecting a type confusion bug according to some exemplary embodiments of the present disclosure.

FIGS. 8, 9, 10, and 11 are diagrams for describing an example of detecting a type confusion bug of a C++ program binary target by BinTyper according to the present disclosure.

FIG. 12 is a general schematic view of an exemplary computing environment in which exemplary embodiments of the present disclosure may be implemented.

### BEST MODE

Various embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an embodiment disclosed in the present disclosure, a detailed description of related known technologies will be omitted if it is determined that the detailed description makes the gist of the embodiment of the present disclosure unclear. Further, the accompanying drawings are only for easily understanding the exemplary embodiment disclosed in this specification and the technical spirit disclosed by this specification is not limited by the accompanying drawings.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present invention pertains. Terms defined in commonly used dictionaries should not be interpreted in an idealized or excessive sense unless expressly and specifically defined.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

In addition, the word “comprises” and/or “comprising” means that the corresponding feature and/or component is present, but it should be appreciated that presence or addition of one or more other features, components and/or a group thereof is not excluded. Further, when not separately specified or it is not clear in terms of the context that a singular form is indicated, it should be construed that the singular form generally means “one or more” in this specification and the claims.

Further, the terms “information” and “data” used in the specification may also be often used to be exchanged with each other.

It should be understood that, when it is described that a component is “connected to” or “accesses” another component, the component may be directly connected to or access the other component or a third component may be present therebetween. In contrast, it should be understood that, when it is described that a component is “directly connected to” or “directly access” another component, no component is present between the component and another component.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention or a usual practice of a user or an operator.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

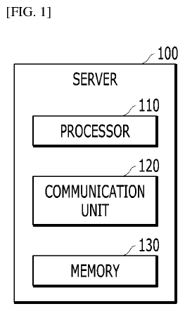

FIG. 1 is a block diagram of a server for detecting a type confusion bug of a C++ program binary target according to some exemplary embodiments of the present disclosure.

According to some exemplary embodiments of the present disclosure, BinTyper provide which is a runtime type confusion tool for C++ binary. Here, a process related to the BinTyper may be performed by a server 100.

Referring to FIG. 1, the server 100 may include a processor 110, a communication unit 120, and a memory 130. However, components described above are not required in implementing the server 100 and the server 100 may thus have components more or less than components listed above.

The server 300 may include, for example, a predetermined type of computer system or computer device such as a microprocessor, a mainframe computer, a digital processor, a portable device, and a device controller. However, the present disclosure is not limited thereto.

The processor 110 of the server 100 generally controls an overall operation of the server 100. The processor 110 processes a signal, data, information, and the like input or output through the components included in the server 100 or drives the application program stored in the memory 130 to provide or process information or a function appropriate for the user.

Further, the processor 110 may control at least some of the components of the server 100 in order to drive the application program stored in the memory 130. Furthermore, the processor 110 may combine and operate at least two of the components included in the server 100 in order to drive the application program.

The communication unit 120 of the server 100 may include one or more modules which enable communication between the server 100 and a user terminal and between the server 100 and external servers. In addition, the communication unit 120 may include one or more modules that connect the server 100 to one or more networks.

A network connecting communication between the server 100 and the user terminal and between the server 100 and external services may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

Further, the network 600 presented herein may use various wireless communication systems such as code division multi access (CDMA), time division multi access (TDMA), frequency division multi access (FDMA), orthogonal frequency division multi access (OFDMA), single carrier-FDMA (SC-FDMA), and other systems.

The network according to the exemplary embodiments of the present disclosure may be configured regardless of communication modes such as wired and wireless modes and constituted by various communication networks including a local area network (LAN), a wide area network (WAN), and the like. Further, the network may be known World Wide Web (WWW) and may adopt a wireless transmission technology used for short-distance communication, such as infrared data association (IrDA) or Bluetooth.

The techniques described in the present disclosure may also be used in other networks in addition to the aforementioned networks.

The memory 130 of the server 100 may store a program for an operation of the processor 110 and temporarily or persistently store input/output data. The memory 130 may include at least one type of storage medium of a flash memory type, a hard disk type, a multimedia card micro type, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The memory 130 may be operated by the control by the processor 110.

According to software implementation, embodiments such as a procedure and a function described in the present disclosure may be implemented by separate software modules. Each of the software modules may perform one or more functions and operations described in the specification. A software code may be implemented by a software application written by an appropriate program language. The software code may be stored in the memory 130 of the server 100 and executed by the processor 110 of the server 100.

Hereinafter, a C++ type system according to some exemplary embodiments of the present disclosure will be described.

Specifically, a type system of a C++ language and a background knowledge for a type confusion bug which is a bug generated due to characteristics of the type system will be described.

First, the type system of the C++ language according to the present disclosure is described as below.

C++ as an object-oriented language may have a class concept. Here, a class may support a member variable and a member function (method) as a user definition type. A user (or a terminal or a server) may generate an object based on the class, and access the member variable of each generated object or call the method. The class may be configured by inheriting different classes. The class that performs inheriting may be defined as a child class or a derived class. Further, classes to be inherited may be defined as a parent class(es). The child class may have a feature of the inheriting parent class.

The child class possesses member variables of the parent class and also possesses the method of the parent class. The child class may additionally define the member variable and the method of the child class itself, which are not present in the parent class. Since the child class is a structure including information of the parent class, the object of the child class may be stored in a parent class type variable. In this case, when an operation (member variable access, method call, etc.) for the parent class type occurs, an information region of the parent class included in the child class may be accessed. Further, C++ may support polymorphism by using a virtual function concept. For example, even though a method having the same name is called, an actually called method may vary depending on the type of object actually stored in the variable.

Next, type conversion and type confusion bugs of the present disclosure will be described as below.

The C++ language may support a typecast operation in order to convert types of variables. The C++ language representatively has four types of typecast operations. Specifically, the C++ language may include typecast operations of reinterpret_cast, static_cast, dynamic_cast, and C-style cast.

Here, the reinterpret_cast may be used as a form of reinterpret_cast <destination_type> (source_variable). Further, the reinterpret_cast may be a typecast operation that does not verify whether the source_variable type and the destination_type are enabled to be converted (compatibility).

Meanwhile, the static_cast may be used as a form of static_cast<destination_type>(source_variable). Further, the static_cast may verify the compatibility between source_variable and destination_type in compile time. Further, the static_cast may check whether the source_variable type and the destination_type are enabled to be compatible because the source_variable type and the destination_type has an inheritance relationship (parent-child class relationship) through class hierarchy with respect to the type conversion which occurs between the class types.

On the other hand, the dynamic_cast is used in a form of dynamic_cast<destination_type> (source_variable). The dynamic_cast may be a typecast operation that verifies the compatibility between the class types in the runtime when the program is executed. Further, the dynamic_cast may verify a type conversion compatibility between an actual type of the object stored in the source_variable and the destination_type at the typecasting time. In order to verify the type conversion compatibility, the dynamic_cast may search RTTI information of the actual object stored in the source_variable.

The reinterpret_cast and static_cast typecast operation operations may be present only in the source code, may be used for verifying the type compatibility in the compile time, and typecast operation related information may not remain in a compiled binary. On the contrary, when the dynamic_cast typecast operation is used, an additional code for performing the type verification is inserted into the binary in the runtime, so information on the typecast operation may remain even in the compiled binary.

On another hand, C-style cast may be used in a form of (destination_type)source_variable. When C-style cast is used, a compiler may attempt typecast in the order of const_cast (typecast operation for removing const of the variable), static_cast, and reinterpret_cast, and use typecast which is first successful. That is, the C-style cast may be the same as one of static_cast and reinterpret_cast. According to some exemplary embodiments of the present disclosure, the type confusion bug may be generated when typecasting and using the variable to the destination type which is not compatible. Typecast operations except for the dynamic_cast verifies the compatibility of the type only in the compile time. Therefore, when the source variable which is not compatible with the destination type is provided in the runtime, the compatibility of the type for the type conversion may not be verified. As a result, the program is executed in a state of considering the variable after the typecast as a wrong type, which may lead to an unintended operation. Wrong type conversion may be prevented by using the dynamic_cast operation that verifies the compatibility of the type in the runtime, but the dynamic_cast verifies the compatibility of the type conversion by searching RTTI, so a program performance may deteriorate. Therefore, large-scale software does not use the dynamic_cast in most type conversion. As a result, there may be a possibility that the compatibility of the typecasting will be verified only in the compile time, and the type confusion bug will be generated.

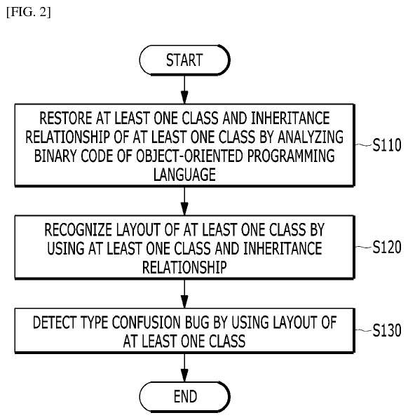

FIG. 2 is a flowchart for describing an example of a method for detecting a type confusion bug according to some exemplary embodiments of the present disclosure.

Referring to FIG. 2, the processor 110 of the server 100 according to some exemplary embodiments of the present disclosure analyzes a binary code of an object-oriented programming language to restore at least one class and an inheritance relationship of at least one class (S110).

Specifically, the processor 110 may extract at least one virtual function table for each of at least one polymorphic class. Further, the processor 110 may recognize a constructor and a destructor for each of at least one polymorphic class by using at least one virtual function table. In addition, the processor 110 may restore the inheritance relationship of at least one class through an overwrite analysis using the constructor and the destructor. Here, the constructor may be a method used when the object is generated in at least one class, and the destructor may be a method used when the object is destructed in at least one class. However, the present disclosure is not limited thereto.

The description of the overwrite analysis is specifically discussed in a thesis “PAWLOWSKI, A., CONTAG, M., VAN DER VEEN, V., OUWEHAND, C., HOLZ, T., BOS, H., ATHANASOPOULOS, E., AND GIUFFRIDA, C. Marx: Uncovering class hierarchies in c++ programs. In NDSS (2017).”, the entire contents of which are incorporated herein by reference.

According to some exemplary embodiments of the present disclosure, the processor 110 may restore at least one class and the inheritance relationship of at least one class, and then recognize a layout of at least one class by using at least one class and the inheritance relationship (S120).

Specifically, the processor 110 may recognize a size of each of at least one class. In addition, the processor 110 may recognize the layout of at least one class by using the size and the inheritance relationship of each of at least one class.

More specifically, when the processor 110 recognizes the size of each of at least one class, the processor 110 may recognize a start offset for at least one class from a register of a CPU. Further, the processor 110 recognizes the size of the object of at least one class, to recognize an end offset for at least one class. In addition, the processor 110 may recognize the size of each of at least one class by using the start offset and the end offset. For example, the processor 110 may recognize the size of each of at least one class by subtracting the start offset from the end offset. However, the present disclosure is not limited thereto.

According to some exemplary embodiments of the present disclosure, the processor 110 may recognize the layout of at least one class, and then detect the type confusion bug by using the layout of at least one class.

Specifically, the processor 110 executes at least one normal binary code to identify at least one target area for the object related to at least one class. In addition, the processor 110 may detect the type confusion bug of the binary code based on the target area.

More specifically, in the case where the processor 110 identifies the target area, when an assembly instruction of at least one normal binary code accesses the memory 130, it may be determined whether the assembly instruction accesses the object stored in the memory 130. When the processor 110 determines that the assembly instruction accesses the object stored in the memory 130, the processor 110 may recognize an address of an access target. Further, the processor 110 calculates a difference value between the address of the access target and a start point of the object to recognize an offset of the object. In addition, the processor 110 may identify the target area for the offset of the object by using the offset of the object and the layout of at least one class. However, the present disclosure is not limited thereto.

Meanwhile, in the case where the processor 110 detects the type confusion bug of the binary code based on the target area, when a target binary is executed and a class constructor is called, a memory address and a class type of the target object may be written. In addition, in the case where the access to the target object occurs, the processor 110 may determine whether the type confusion bug is generated according to whether there is the target area related to the target object.

For example, when the processor 110 determines whether the type confusion bug is generated according to whether there is the target area related to the target object, in the case where there target area related to the target object is not present in the written class type, the processor 110 may determine that the type confusion bug is generated. However, the present disclosure is not limited thereto.

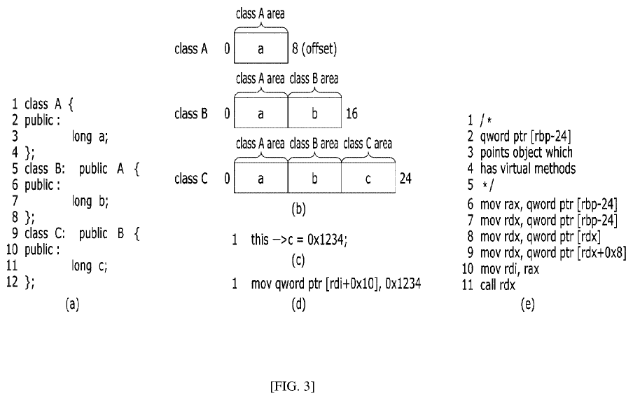

FIG. 3 is a diagram for describing an assembly expression of a C++ source code according to some exemplary embodiments of the present disclosure.

Referring to FIG. 3, an assembly expression of a C++ source code according to some exemplary embodiments of the present disclosure will be described. Here, the C++ source code may be converted into the assembly instruction at the binary level.

Specifically, how the class related C++ source code is expressed as the assembly instruction is described. The compiler mentioned below may mean a compiler that uses Itanium C++ ABI (Non-patent document [14]).

First, the class layout and inheritance of the present disclosure are described as below.

FIG. 3(a) illustrates a C++ class source code sample, and FIG. 3(b) illustrates the layout of the class of the C++ class source code sample of FIG. 3(a).

The compiler allocates the memory in order to construct the object. The size of the allocated memory may be determined by sizes of member variables defined in the class, and the object may be located in the allocated memory.

Specifically, referring to FIG. 3(a), the class definition and the memory layout of the constructed object are illustrated. The member variables of the class may be located sequentially from the start point (this) of the object. For example, when the class has a virtual method (virtual function), a point indicating VTable may be located at a first start point of the object, and the member variables may be located immediately after the point (the point indicating VTable becomes a first member variable).

According to some exemplary embodiments of the present disclosure, when the class inherits the parent class, the corresponding child class may have the member variable and the method of the parent class, and additionally have the member variable and the method thereof.

Referring to FIG. 3(b), a class layout of the child class is illustrated. The class layout of the child class may be configured in a form in which the member variable of the child class is located behind the class layout of the parent class.

Next, the class member variable and the method of the present disclosure are described as below.

The class member variables may be located in succession from a first part of the object allocated to the memory. The access to the member variable of the object may be configured in a form to access an address in which a specific offset (determined according to the member variable) is added to a start address (this pointer) of the object.

Referring to FIG. 3(c), a C++ sample code and an assembly expression which access the member variable of the object are illustrated. A member variable c may be located in offset 0x10, and a register rdi may indicate this pointer. In this case, a code that substrates 01234 in the member variable c may be expressed as illustrated in FIG. 3(d).

Next, the class constructor and destructor of the present disclosure are described as below.

The class constructor and destructor may be special methods called when the object is constructed or destructed. The child classes that inherit the parent class may have (1) a feature of calling the constructor of the parent class before performing a code of the constructor thereof and (2) a feature of calling the destructor of the parent class after performing the code of the destructor thereof.

The constructor and the destructor of the child class may call the constructor and the destructor of the parent class by using this pointer thereof as this pointer of the method call. Since this pointer transferred to the constructor and the destructor of the parent class is the same as this pointer transferred to the constructor and the destructor of the child class, the same object may be initialized or organized.

Next, the virtual function table and the virtual function call of the present disclosure will be described as below.

C++ may use a virtual function concept in order to implement the polymorphism. A class (polymorphic class) having a virtual method may have a data structure called VTable for each class. Addresses of the virtual method may be stored in VTable. The VTable may be stored in a read-only section of a binary file. In the constructor of the polymorphic class, the address of the VTable may be stored as a first member variable at an object start point.

Specifically, referring to FIG. 3(e), a process of the virtual method call is illustrated. The virtual method call may read a first member variable of the object and acquire the address of the VTable (1). Further, the virtual method call may acquire the address of an actual virtual method function by adding an offset corresponding to the corresponding virtual method in the VTable (2). Further, the virtual method call may call the acquired virtual method function (3). Therefore, the called virtual method may vary depending on an object actually provided in the runtime.

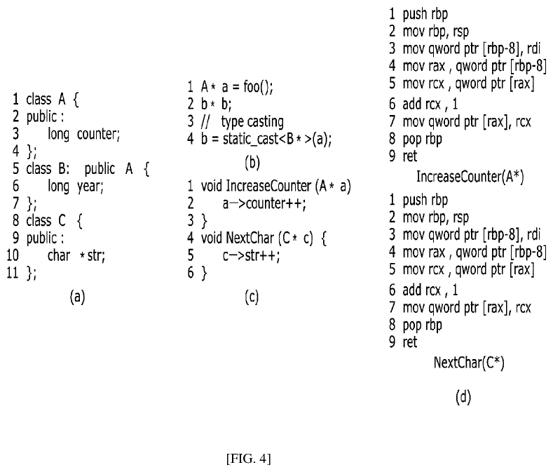

FIGS. 4, 5, 6, and 7 are diagrams for describing a method for detecting a type confusion bug according to some exemplary embodiments of the present disclosure.

According to some exemplary embodiments of the present disclosure, BinTyper may be provided which is a runtime type confusion tool which may be applied to a C++ binary. The BinTyper may analyze class hierarchy and a layout in the class by performing a static analysis. In addition, the BinTyper may identify information of a target object for correctly executing the assembly instructions which interact with the object without generating the type confusion bug through a dynamic analysis. Thereafter, the BinTyper may execute the target binary and detect the runtime type confusion bug based on the identified information.

Here, the BinTyper may be stored in the memory 130 of the server 100, and executed by the processor 110 of the server 100. However, the present disclosure is not limited thereto.

The BinTyper of the present disclosure may detect the type confusion bug at a point where a target application accesses a member variable of a polymorphic object. The target application may have a type confusion error, and the type confusion error may be triggered when a malformed input is given.

In the following description, it is assumed that the source code is not given, and a target C++ binary does not include debugging and symbol information including RTTI. Further, the target C++ binary targets a binary compiled based on Itanium C++ ABI (Non-patent document [14]). Meanwhile, various existing studies are performed for Itanium C++ ABI, and Itanium C++ ABI is used in a major Linux C++ compiler such as GCC, Clang/LLVM.

Referring to FIG. 4, since there is no high-level information such as the source code, key challenges should be solve in detecting the type confusion bug in the binary. FIG. 4 illustrates an example of the challenges.

First, FIG. 4(a) illustrates an example of the C++ class.

According to some exemplary embodiments of the present disclosure, absence of the type casting operator should be solved in order to detect the type confusion bug in the binary.

FIG. 4(b) illustrates an example of downcasting.

Specifically, type casting of Line 4 may be downcasting. Therefore, in the case of an actual object indicating a variable a is not Class B and derived class of B, the type

confusion bug may be generated. Studies (Non-patent documents [31], [26], and [28]) for the existing source-level type confusion bug detection intend to detect the type confusion bug by adding a code for verification to the typecasting operators. The inserted code checks whether the actual type of the source object may be converted into the destination type. However, the typecasting operator is present only the source code except for the dynamic_cast. As a result, the typecasting operator may not be present in compiled C++ binaries, which may make it difficult to determine a performing time of a detection task of the type confusion error.

Next, according to some exemplary embodiments of the present disclosure, absence of the class information should be solved in order to detect the type confusion bug in the binary.

FIG. 4(b) illustrates typecasting from Class A to Class B in Line 4.

Specifically, in order to confirm the safety of the typecasting, inheritance relationship information (class hierarchy) between the actual object type and the destination type of typecasting is required. As described above, the C++ compiler may remove the high-level information during compiling. As a result, class hierarchy information may not be present in the compiled C++ binary.

Next, according to some exemplary embodiments of the present disclosure, dynamic type information which may not be known should be solved in order to detect the type confusion bug in the binary.

FIG. 4(c) illustrates source codes of two functions, i.e., IncreaseCounter and NextChar.

Specifically, each function requires different types of factors and accesses the member variable of each factor. (1) The function IncreaseCounter may receive a factor class A, and increase a value of an int-type member variable of a name called counter by 1. In addition, (2) the function NextChar may receive a factor class C, and increase a value of a char*-type member variable of a name called str by 1.

FIG. 4(d) illustrates the assembly code constructed in the source code illustrated in FIG. 4(c) by the C++ compiler.

Specifically, even though the high-level information of the source code is removed, so the function operates for different classes and different member variables, the functions IncreaseCounter and NextChar may have the same assembly code. As a result, it may be difficult to know the type of object required for executing benign of the assembly code.

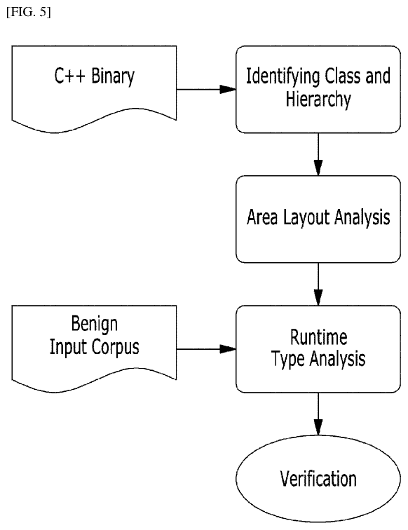

Referring to FIG. 5, a flowchart in which the BinTyper solves the challenges by referring to FIG. 4 is illustrated.

As illustrated, when the C++ binary is input, the BinTyper of the present disclosure may identify (restore) the class and inheritance structure (IDENTIFYING CLASS AND HIERARCHY).

Further, the BinTyper of the present disclosure may identify the class and inheritance structure, and then analyze an area layout (AREA LAYOUT ANALYSIS).

Further, the BinTyper of the present disclosure may analyze the area layout, and then when Corpus is input (BENIGN INPUT CORPUS), the BinTyper may analyze a runtime type (RUNTIME TYPE ANALYSIS).

In addition, the BinTyper of the present disclosure may detect a confusion bug through the runtime type analysis.

The above-described steps will be described below in detail.

The BinTyper of the present disclosure may execute the binary, and detect the type confusion bug generated by targeting the polymorphic class.

A primary feature of the BinTYper is described as below.

First, the class inheritance structure is recoverable in the BinTyper.

In the compile process, the high-level information which is present in the source code including the class inheritance structure may be removed. As a result, class information or inheritance (parent-child) relationship information created in the source code may not be directly revealed in the compiled binary. Nevertheless, it may be possible to perform a task that indirectly identify the class from the assembly expressions for implementing the C++ class concept, and restoring the inheritance relationship between the classes, such as the constructor/destructor call, the virtual function table, etc.

Existing many studies (Non-patent documents [24], [30], [42], [35], and [23]) show that the class and the class inheritance relationship information may be restored from the binary by utilizing indirect information.

Next, the assembly code constructed in the BinTyper is unique.

FIGS. 4(c) and 4(d) illustrate source codes of two functions and assembly codes constructed from the corresponding source codes. Even though two functions operate with respect to different variable types, the same assembly expression is constructed. Even though both two functions are expressed as the same assembly code, the assembly expressions corresponding to the respective functions are distinguished and constructed, and the functions are also distinguished and used. That is, a variable type used by the assembly code corresponding to one function is uniquely designated.

Next, in the BinTyper, the class object is constituted by several areas.

FIG. 3(b) illustrates an internal structure of the class object on the memory. The class object is constituted by a parent class area and an own class area, and the own class area is located consecutively after the parent class area. The parent class area means a space in which the member variables defined in the parent class are located, and the own class area means a space in which members variables additionally defined in the corresponding class are located. Area layout information (hereinafter, referred to as area layout information) inside the class object may be accumulated when inheritance is made several times. For example, when it is assumed that there are class A, child class B of class A, and child class C of B, and each class has one member variable a, b, c, the area layout of class C may be constituted in the order of class A area, class B area, and class c area as illustrated in FIG. 3(a). The member variable a may be located in the class A area, the member variable b may be located in the class b area, and the member variable c may be located in the class c area. The area layout information may be inferred through the class hierarchy, the class constructor, and the member functions.

According to some exemplary embodiments of the present disclosure, the type confusion bug may be generated when the area is not present.

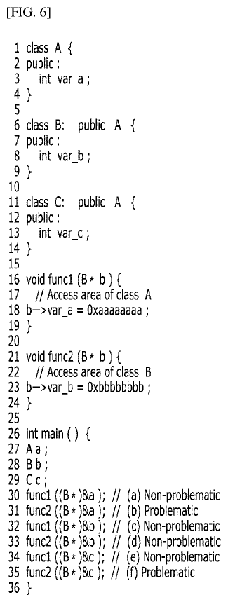

According to Lines 30 to 35 of the code illustrated in FIG. 6, a code is described, which converts the type of the factor into B* to call function func1 and func2. Here, the function func1 may access a member variable var_a defined in parent class A of class B. The function func2 may access the member variable var_b defined in class B which is the derived class.

That is, in the function call by codes described in Line 32 and Line 33, a problem may not occur because an object in which the actual class type is B is converted into class B type.

Meanwhile, the function all by the code described in Line 30 accesses only the class A area in the area of the object transferred by the func1 function factor, the object in which the actual class type is A is converted (downcasted) into the class B type, but the problem does not actually occur. Therefore, when the class A area is present in the object transferred by the factor, the function call may correctly operate without occurrence of type confusion. Further, since the actual class type of the object transferred by the factor is A and the class A area is present, the problem may not occur. Further, the function call by the code described in Line 34 also converts the object in which the actual class type is C into the class B type, but the class A area is present, so the function call may operate without a problem.

On the contrary, in the function calls by the codes described in Lines 31 and 35, the function func2 requires the class B area, but both class A and class C which are actual class types of the codes described in Lines 31 and 35 have no class B area, so this may be typecasting which becomes a problem. In many existing studies (Non-patent documents [31], [26], and [28]), the type confusion bug is detected based on the typecasting operator of the source code. However, since the typecasting operator disappears in the compile process, it may be difficult to apply a similar access to the binary. Instead, as a different access method, whether an area to be accessed by the present disclosure is present in the actual class type of the object is checked to detect the type confusion bug regardless of the absence of the type casting operator. Specific area being present in the object may indicate that the class type of the object is a class corresponding to the relevant area or the child class of the class corresponding to the relevant area. Therefore, if the area to be accessed is not present in the actual class type of the object, it may be known that the type confusion bug is generated. This is a key idea of the BinTyper, and in the present disclosure, a method for performing type confusion bug detection by checking the presence of the area may be defined as area-based type confusion bug detection.

The BinTyper of the present disclosure may detect the type confusion bug at the time of performing the assembly instruction which accesses the object. The detection of the type confusion bug may be performed through the area-based type confusion bug detection that checks whether a specific area is present in the object accessed by the assembly instruction. The detection of the type confusion bug may be performed without the typecasting operator, so the detection of the type confusion bug may be applied regardless of the absence of the type casting operator. Here, ‘specific area’ may mean an area accessed when the assembly instruction is executed normally without the type confusion bug. Since assembly codes constructed from source codes using different types, respectively may be the same, whether the specific area is present may not be known only a single assembly instruction paragraph. The high-level information which is present in the source code is removed in the compile process, so in order to solve this, the BinTyper may apply both the dynamic analysis and the static analysis. In the dynamic analysis, runtime access information may be written while the target binary is normally executed without the generation of the type confusion bug. The runtime access information may include an executed assembly instruction, type information of an object accessed by the assembly instruction, and an offset from a start address of the accessed object. Thereafter, area layout information indicating an area structure of inside the class object is analyzed. To this end, class hierarchy information is required. Class inheritance and class hierarchy information is not present in the binary, and studies for restoring an inheritance hierarchy structure through the static analysis from the compiled binary are proposed previously, and the BinTyper of the present disclosure may restore the class hierarch information by using the studies. As such, the BinTyper of the present disclosure may find an area accessed by each instruction based on the runtime access information and the area layout information. The area-based type confusion bug detection may be performed immediately based on the information, but a replicated verification is performed and whether the same area is present is checked several times, so it is inefficient to perform the verification whenever the assembly instruction of accessing the object is executed. Therefore, the BinTyper of the present disclosure may determine points where replicated inspection may be performed by performing optimization through the static analysis, and perform the area-based type confusion bug detection at a point other than the determined points.

According to some exemplary embodiments of the present disclosure, BinTyper which is a tool for detecting the generation of the type confusion bug is developed by targeting the compiled C++ binary.

Specifically, as illustrated in FIG. 5, the BinTyper of the present disclosure may include an Identifying Class and Hierarchy step, an Area Layout Analysis step, a Runtime Type Analysis step, and a Verification step.

The Identifying Class and Hierarchy step as a first step may include a step in which the BinTyper determines the class and the class hierarchy through the static analysis. Specifically, there are existing studies (Non-patent documents [24], [30], [42], [35], [38], and [23]) for identifying the class and restoring the hierarchy from the compiled binary. The BinTyper may restore the class hierarchy based on the studies. The BinTyper operates by targeting the polymorphic class, and may extract a virtual function table and use the extracted virtual function table as a unique representation for each polymorphic class. In addition, the BinTyper may identify constructor-destructor by performing the static analysis, and apply an overwrite analysis (Non-patent document [35]). The BinTyper may restore the class hierarchy by inferring the inheritance relationship based on the result.

The Area Layout Analysis step may include a step in which the BinTyper analyzes the area layout information of class objects based on the restored class hierarchy. The area layout information is a set of information (the start offset and the end offset of the area) of respective areas constituting the class object. The BinTyper of the present disclosure extends Minimum Object Size Analysis of Declassifier (Non-patent document 23) for analysis of an area layout.

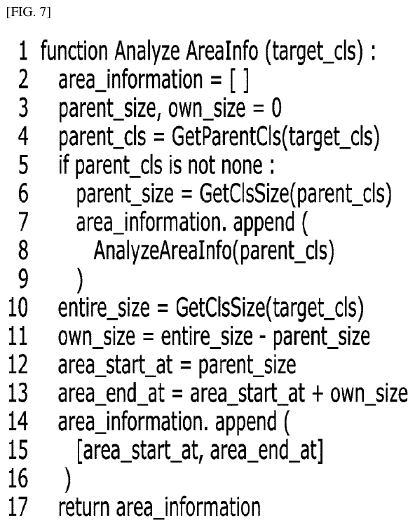

Referring to FIG. 7, an algorithm of analyzing the area layout information is illustrated. Specifically, in FIG. 7, the access to the member variable in the assembly code is expressed by a scheme of accessing a memory address in which an offset value corresponding to a location of a target member variable is added to a this pointer indicating the object address. Therefore, the BinTyper of the present disclosure may infer a total size of a member variable area by statically analyzing accesses to a member variable memory of the object. The BinTyper may know the size of patent-area by identifying the parent class through the class hierarchy and calculating the size of the member variable area of the parent class. The size of the own class area may be calculated by subtracting the size of the parent area from the entire size of the member variable area of the relevant derived class. For example, when there is a class having a size of 4 and there is a child class of a class having a size of 12, the area layout information of the child class becomes {parent: {offset: 0, size: 4}, Own: {offset: 4, size: 8}}.

The Runtime Type Analysis step may be a step in which the BinTyper designates which area being present is to be checked in order to perform the area-based type confusion bug detection. In the BinTyper, target areas required for normal execution of codes may be different even with respect to the same assembly codes, respectively. Therefore, the target area may be correctly identified only by accurately determining an object type which may be transferred by the relevant code. The BinTyper may perform the dynamic analysis in the Runtime Type Analysis step in order to determine the transferred object type. The BinTyper may execute the target binary, and determine whether the assembly instruction accesses the object when the assembly instruction accesses the memory. For example, when the assembly instruction accesses the object, the BinTyper calculates the offset by calculating a difference between an access target address and an object start point to identify the target area by identifying which area of the object is accessed based on the area layout information. Here, the target area may be a point where the area-based type confusion bug detection is to be performed for the identified codes in a subsequent step.

The Verification step may include a step in which the BinTyper executes the target binary and performs the area-based type confusion bug detection at identified points. The BinTyper may write a memory address and a class type of a target object when the class constructor is called. When the BinTyper accesses the written object, the BinTyper may check whether the target area is present in the class type of the accessed object, and announce that the type confusion bug is detected if the target area is not present.

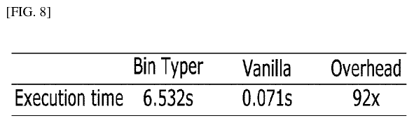

FIGS. 8, 9, 10, and 11 are diagrams for describing an example of detecting a type confusion bug of a C++ program binary target by BinTyper according to the present disclosure.

Referring to FIG. 8, a table illustrated in FIG. 8 includes a measurement result acquired by applying the BinTyper of the present disclosure to PDFium which is a PDF library. Here, the PDFium is an open library of Google used for supporting a PDF document in various software including Chrome which is a web browser of Google. The BinTyper may confirm that CrBug-983137(https://bugs.chromium.org/p/chromium/issues/detail?id=983137) which is the type confusion bug is detected by targeting the PDFium.

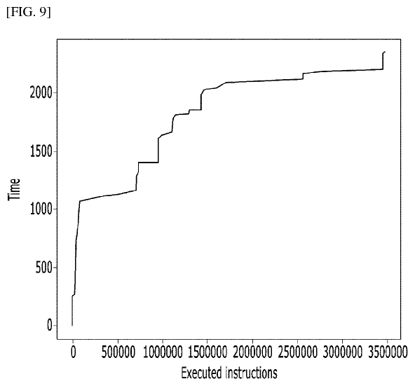

Referring to FIG. 9, a required time may be confirmed as compared with an instruction executed when applying the BinTyper of the present disclosure.

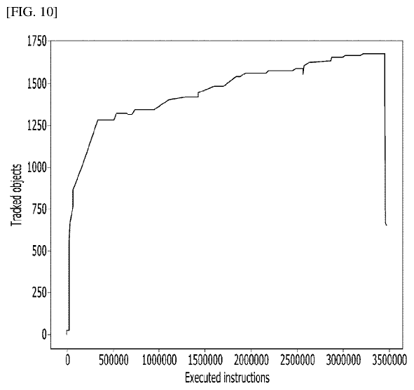

Referring to FIG. 10, the number of tracking target objects may be confirmed as compared with the executed instruction, which is measured by executing the BinTyper of the present disclosure.

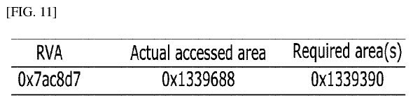

Referring to FIG. 11, information provided by the BinTyper at the time of detecting the type confusion bug may be confirmed.

When the BinTyper detects the type confusion bug, the BinTyper may provide information on a fault instruction address (RVA), an actual accessed area, and a required area(s). However, the present disclosure is not limited thereto.

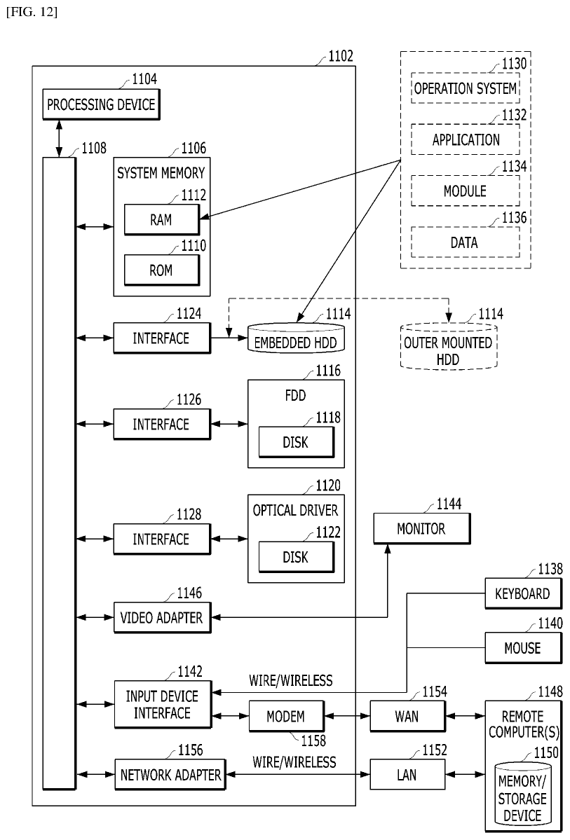

FIG. 12 is a simple and general schematic diagram illustrating an example of a computing environment in which exemplary embodiments of the present disclosure are implementable.

FIG. 9 is a simple and general schematic diagram illustrating an example of a computing environment in which exemplary embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an exterior mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least three devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

### MODE FOR DISCLOSURE

Related contents in the best mode for carrying out the present invention are described as above.

### INDUSTRIAL APPLICABILITY

The present disclosure relates to software security bug detection, and particularly, to binary security bug generation detection through a dynamic analysis.

1. A method for detecting a type confusion bug of a binary code target of an object-oriented programming language using a processor of a computing device, the method comprising:
restoring at least one class and an inheritance relationship of the at least one class by analyzing a binary code of the object-oriented programming language;
recognizing a layout of the at least one class by using the at least one class and the inheritance relationship; and
detecting the type confusion bug by using the layout of the at least one class.

2. The method for detecting the type confusion bug of claim 1, wherein the restoring of the at least one class and the inheritance relationship of the at least one class by analyzing the binary code of the object-oriented programming language includes
extracting at least one virtual function table for each of at least one polymorphic class,
recognizing a constructor and a destructor for each of the at least one polymorphic class by using the at least one virtual function table, and
restoring the inheritance relationship of the at least one class through an overwrite analysis using the constructor and the destructor.

3. The method for detecting the type confusion bug of claim 2, wherein the constructor is a method used when the object is generated in the at least one class, and
the destructor is a method used when the object is destructed in the at least one class.

4. The method for detecting the type confusion bug of claim 1, wherein the recognizing of the layout of the at least one class by using the at least one class and the inheritance relationship includes
recognizing a size of each of the at least one class, and
recognizing the layout of the at least one class by using the size of each of the at least one class and the inheritance relationship.

5. The method for detecting the type confusion bug of claim 4, wherein the recognizing of the size of each of the at least one class includes
recognizing a start offset for the at least one class from a register of a CPU,
recognizing the size of the object of the at least one class to recognize an end offset for the at least one class, and
recognizing the size of each of the at least one class by using the start offset and the end offset.

6. The method for detecting the type confusion bug of claim 1, wherein the detecting of the type confusion bug by using the layout of the at least one class includes
executing at least one normal binary code to identify at least one target area for the object related to the at least one class, and
detecting the type confusion bug of the binary code based on the target area.

7. The method for detecting the type confusion bug of claim 6, wherein the executing of the at least one normal binary code to identify the at least one target area for the object related to the at least one class includes
determining whether an assembly instruction accesses an object stored in a memory when the assembly instruction of the at least one normal binary code accesses the memory, recognizing an address of an access target when it is determined that the assembly instruction accesses the object stored in the memory,
recognizing an offset of the object by calculating a difference value between the address of the access target and a start point of the object, and
identifying the target area for the offset of the object by using the offset of the object and the layout of the at least one class.

8. The method for detecting the type confusion bug of claim 6, wherein the detecting of the type confusion bug of the binary code based on the target area includes
writing a memory address and a class type of a target object when a target binary is executed and a class constructor is called, and
when access to the target object occurs, determining whether the type confusion bug occurs according to whether the target area related to the target object is present.

9. The method for detecting the type confusion bug of claim 8, wherein when the access to the target object occurs, the determining of whether the type confusion bug is generated according to whether the target area related to the target object is present includes
when the target area related to the target object is not present in the written class type, determining that the type confusion bug is generated.
